(19) United States
(12) Patent Application Publication
(10) Pub. No.: US 2016/0106522 A1
(43) Pub. Date: Apr. 21, 2016

(54) ORTHODONTIC CLIP DEVICE

(71) Applicant: Ki Soo KIM, Seoul (KR)

(72) Inventor: Ki Soo KIM, Seoul (KR)

(21) Appl. No.: 14/889,265

(22) PCT Filed: Sep. 9, 2013
(86) PCT No.: PCT/KR2013/008107

§ 371 Date: Nov. 5, 2015

(30) Foreign Application Priority Data
May 6, 2013 (KR) 10-2013-0050651

(51) Int. Cl. A61C 7/28; A61C 7/16; A61C 7/14

(52) U.S. Cl. CPC A61C 7/28; A61C 7/148; A61C 7/16

(57) ABSTRACT

The present invention relates to a clip device for orthodontic treatment wherein appropriate force is applied to a tooth so as to move the tooth to a desired position, thereby correcting the tooth into a normal tooth alignment, and the clip device comprises: a clip base made of a ceramic material, having a base portion directly joined to a tooth, projecting an inner back portion toward the outside of the base portion, having a wire insertion hole with an opened upper portion formed between the inner back portion and an outer front portion, which is projected at a distance from the inner back portion, for allowing a connection wire to be inserted therein, and having a wire fixing hole and a clip operation hole formed below the wire insertion hole; and an elastic clip having a fixing clip, which is a fixing means made from a metal material, integratedly coupled to the wire fixing hole toward the inner back portion and the clip operation hole toward the outer front portion of which the spaces communicate with each other at the lower portion of the wire insertion hole, and formed from a resilient means made of a metal material at the upper portion of the clip operation hole, in order to resiliently support, bind and fix the connection wire inserted through the wire insertion hole of the clip ase to the wire fixing hole and to induce sliding in a binding operation of the connection wire.

### TECHNICAL FIELD

The present invention relates to an orthodontic clip device used for the correction process to a normal teeth correction state by applying appropriate forces to the teeth to move the teeth to the desired location, and more particularly, to an orthodontic clip device in which an orthodontic clip and a connecting wire for connecting and grasping the orthodontic clip can be naturally elastically bound through elastic restoration of a elastic member configured in the orthodontic clip, while being simply inserted to the bottom from the top of the orthodontic clip, thereby enabling the stable fixation and clean and beautiful wearing state of the teeth, while providing the easy and simple treatment.

### BACKGROUND ART

In general, the orthodontic (dentition correction correction) treatment means a treatment of correcting a variety of skeletal disharmony that may occur in the course of growth, including simply aligning the crooked teeth to allow a normal teeth function, thereby making a healthy oral tissues and beautiful face figure. That is, it means functional/aesthetic treatments that move the teeth to a desired location in the alveolar bone by applying an appropriate force to the teeth.

In particular, a case where the teeth are not equally grown is called malocclusion, in the case of the malocclusion, it externally looks bad, it is not possible to functionally chew the food, and the pronunciation can be adversely affected. Furthermore, when leaving the malocclusion, the possibility of the occurrence of dental caries or periodontal disease becomes increase, and other parts of the body are also affected for a long period of time, which may induce or further worsen other diseases.

Therefore, when there is a malocclusion, it is desirable to move the teeth to the correct position and posture through the dentition correction to maintain the state of correct dentition correction. Indeed, many people acquire confidence in appearance through the orthodontic, and in some cases, often cure other diseases misunderstood as independent of the teeth through the orthodontic.

Meanwhile, an orthodontic device used as a correcting means of teeth requires a connecting wire for holding and tightening the teeth together to rightly correct the teeth when the teeth are unevenly arranged or a gap is spread, and a fixing means for fixing the connecting wire, and the orthodontic clipping device is applied at this time.

In the orthodontic clip device having such a function, in general, as a method of holding the connecting wire, a method of holding the connecting wire to the base portion of the clip base by the use of an auxiliary line, a method of fixing the connecting wire by covering or fixing it by a fixing clip after inserting the connecting wire by another fixing clip mounted on the top of the clip base, and a method of holding the connecting wire by coupling a separate lid formed on the clip base by the connecting wire are introduced.

However, since all the existing methods are methods of fixing the clip base bonded to the teeth by inserting the connecting wire from the front based on the teeth, the insertion and fixing works of the connecting wire are structurally very hard and inconvenience, and the problems of structural inconvenience and hygienic defect, such as a decline in orthodontic force to the teeth and the easy detachment of the connecting wire from the clip base itself are not still solved.

Thus, in terms of improvement in treatment convenience, reduction of and treatment period and the reduction of the treatment costs, there are demands for the development and need for orthodontic devices capable of accurately and stably transmitting the corrective force provided by the connecting wire to the teeth, while easily replacing the clip base of the bracket structural through the easy and simple work by an operator, depending on the situation or environment of the orthodontic treatment

### DISCLOSURE

### Technical Problem

An embodiment of the present invention is directed to an orthodontic clip device of all new construction principle in which an insertion hole for vertically inserting a wire from top to bottom, and s fixing hole formed in a horizontal direction to the insertion hole are configured, as a base bottom surface, a base of ceramic and an injection material formed with a mesh-like groove surface to easily adhere to the teeth, and an elastic plate clip made of a metallic material is formed inside the base to inset and fix the connecting wire inserted into a base inner hole, the metal plate is molded in a plane shape for the horizontally smooth sliding of the wire to which the wire contact surface of the fixing hole formed inside the base is inserted, and the sliding of the connecting wire is improved together with the smooth insertion and fixation of the connecting wire after installing the orthodontic clip device to the teeth, thereby providing the easy treatment and treatment effect. Thus, the easiness of the work and the reduction of time can be attained, by vertically inserting the connecting wire from the top of the base portion, and by enhancing the fixing force with the easy insertion using the elastic restoring force of the elastic plate member.

### Technical Solution

According to an aspect of the present invention, there is provided an orthodontic clip device including: a clip base made of a ceramic material in which a base portion directly bonded to the teeth, an internal rear portion protrudes to the external side (outside) of the base portion, a wire insertion hole with an open top is formed between an external front portion protruding with an interval from the internal rear portion so that a connecting wire can be inserted, and a wire fixing hole and a clip operating hole are formed below the wire insertion hole; and an elastic clip in which the connecting wire inserted through the wire insertion hole can be elastically supported and bound by the wire fixing hole, a fixing clip as a fixing means made of a metallic material integrally coupled to the wire fixing hole of the internal rear side and the clip operating hole of the external front side spatially communicating with the lower side of the wire insertion hole is fixed so that the sliding can be induced in the binding operation of the connecting wire, and the upper side of the clip operating hole is formed of an elastic means.

Further, the elastic clip is configured so that the upper support part is integrally coupled to the internal part of the external front part in which the wire insertion hole is located, or is inserted and coupled to a clip binding groove recessed on the external front part, the intermediate elastic part is sloped so that the elastic function can be operated on the inserted connecting wire, a pressing part protrudes from the lower side below the elastic part, and is supported by an upper catching part integrally coupled to the clip fixing groove of the internal rear part in which the wire fixing hole is located.

Further, the wire insertion hole of the clip base is configured so that an opened upper space is formed to be smaller in size than a width of the lower space in which the elastic clip so that the connecting wire can be smoothly inserted and operated, the upper part and the internal part facing each other of the internal rear part and the external front part forming the wire insertion hole are preferably formed in a curved shape. Especially, the base part of the clip base is configured so that the bonding part of the base portion is formed a curved shape so as to be evenly bonded and bound to the teeth, the lower part and the side part are tapered so that the tool can be caught when detaching the clip base from the teeth, and the bonding part of the base portion preferably forms a mesh-like embossed surface so that the bonding capability is improved to the teeth

In addition, the clip base is formed so that the wire insertion hole is formed in a vertical direction (0 angle direction) in which the connecting wire inserted and operated from top to bottom through the wire insertion hole is basically parallel to the teeth depending on the conditions of the teeth and the correcting method, or the wire insertion hole is formed in a slope direction (+ angle form or − angle form) on each of the front or the rear with respect to the teeth, and thus, the elastic clip and the fixing clip are also obliquely installed and coupled. In particular, the clip base is configured so that the direction to the teeth, the direction to the front part of the external front part as instruction marks of a line and a circle representing the center, and the center mark are selectively applied, and the clip fixing groove of the wire fixing hole to which the fixing clip is coupled and fixed is formed to be smaller than the cross-sectional area of the connecting wire to be inserted and bound

In addition, in the orthodontic clip device of the present invention, the clip base made of a ceramic material, and the elastic clip and the fixing clip made of a metallic material may be configured as a single structure or a plurality of integral structures adjacent to each other. Furthermore, it is a matter of course that the more simple configuration can be attained by omitting the fixing clip serving as the fixing means made of a metallic material coupled to the clip fixing hole as the wire fixing hole of the internal rear side spatially communicating with the lower side of the wire insertion hole so that the connecting wire inserted through the wire insertion hole of the clip base can slide in the binding operation.

### Advantageous Effects

The orthodontic clip device of the present invention can provide effects in which treatment of the teeth to be subjected to the orthodontic treatment is easy and simple, the stable and fixed conditions of the teeth and the clean and beautiful wearing conditions can be structurally maintained, since the orthodontic clip serving as the clip base of a metallic material and the connecting wire made of a metallic material for connecting and holding the orthodontic clip are simply inserted from top to bottom (vertically on the top) into the internal space with the open top of the orthodontic clip, and the connecting wire can be naturally elastically bound through the elastic restoring force of the elastic clip serving as a metallic elastic member configured in the internal space of orthodontic clip. Thus, it is expected that it is possible to consequentially improve the treatment convenience of the orthodontic treatment and to significantly reduce the time and cost taken for the orthodontic treatment.

### BRIEF DESCRIPTION OF THE DRAWINGS

FIGS. 1a to 1b are perspective views of an orthodontic clip illustrating a basic structure in which a metallic fixing clip is basically configured in a clip fixing groove as a wire fixing hole position at which a space is formed in the clip base made of a ceramic material and a connecting wire is bound and fixed by the orthodontic clip as the orthodontic clip device of the present invention, and an application structure in which the fixing clip is omitted.

FIG. 2 is a perspective view of the orthodontic clip which is the orthodontic clip applying device of the present invention before the connecting wire is bound to the orthodontic clip.

FIGS. 3 and 4 are a schematic plan view and a front view of a use state in which the orthodontic clip device according to the present invention is installed in the teeth and the dentition correction is performed.

FIGS. 5, 6a and 6b are step-by-step perspectives and schematic cross-sectional views in which the metallic connecting wire is simply inserted from top to bottom through the wire insertion hole with the open top between the external front and the internal rear formed of a ceramic material forming the clip base according to the orthodontic clip of the present invention, is naturally elastically fastened by the elastic clip of the metallic elastic structure and the fixing clip and the fixing clip of the fixing structure installed on the external front and the internal rear, and can be bound and finished, thereby attaining the easy and stable wearing state to the teeth.

FIG. 7 a structural view of an operation state which is elastically operated to the connecting wire to which the metallic elastic clip is inserted and bound in the clip base made of a ceramic material forming the orthodontic clip device of the present invention, and naturally binds and fixes the connecting wire to the metallic fixing clip, while being pressed.

FIG. 8 is a cross-sectional state structure view of the embodiments in which the vertical and horizontal angles of the wire insertion hole and the clip operating hole to which the connecting wire is inserted and fastened can be variously applied and changed, without a change in shape of the clip base of the orthodontic clip as the orthodontic clip device of the present invention.

FIG. 9 is a cross-sectional view in which the elastic support means of the connecting wire forming the orthodontic clip device of the present invention is directly integrally coupled to the exposed inner side of the front external front of the clip base or is inserted and integrally coupled to the clip binding groove formed on the external front.

FIG. 10 is a perspective view of an application state in which the orthodontic clip as the orthodontic clip device of the present invention is formed in a double structure.

### BEST MODE FOR THE INVENTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various FIGS. and embodiments of the present invention.

Hereinafter, a specific configuration relation and its embodying principle of the orthodontic clip device according to the present invention will be described in detail with reference to the drawings of the preferred embodiments.

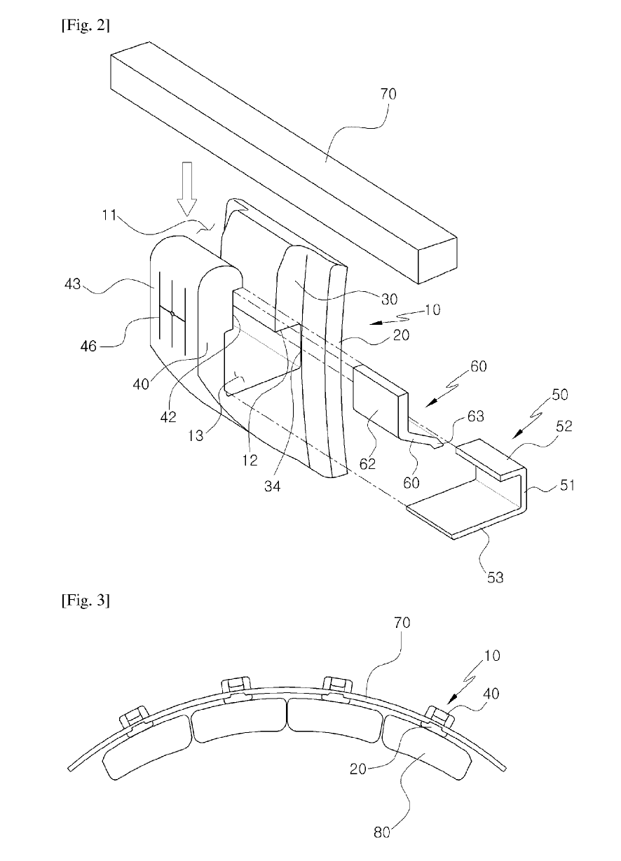

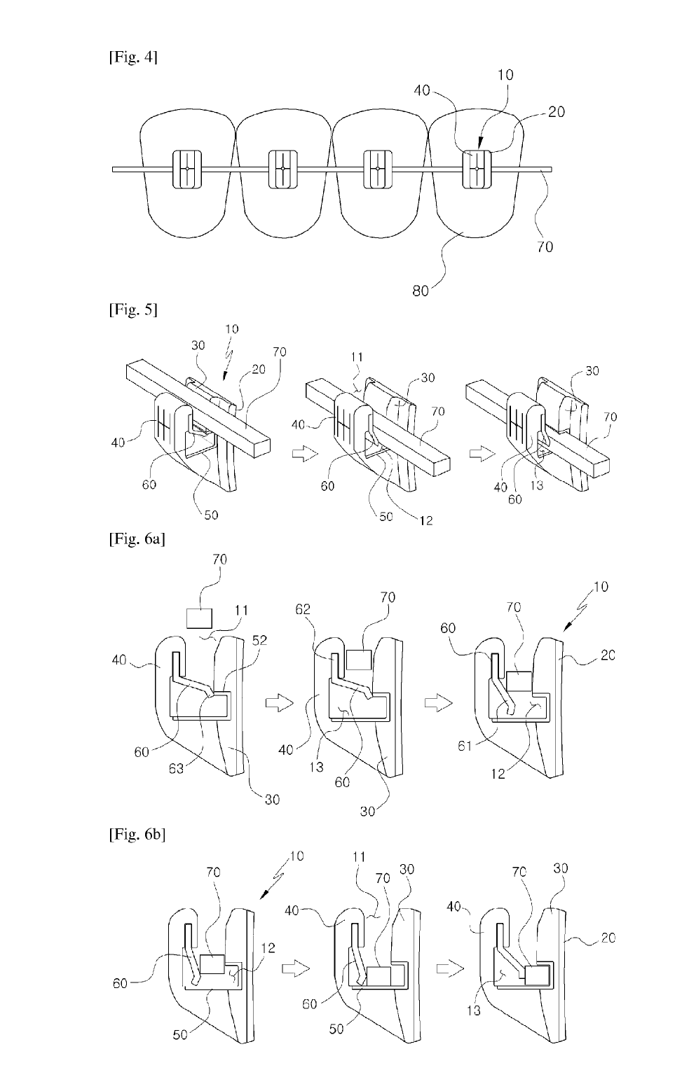

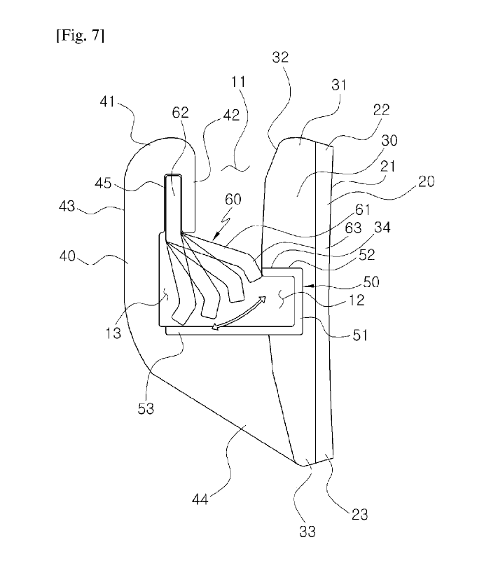

Basically, as illustrated in the use state diagrams of FIGS. 3 and 4, in the present invention, a clip base 10 as an orthodontic clip usually made of a ceramic material, and a connecting wire 70 for connecting and holding the connecting wire 70 are simply inserted from the top to the bottom (from the top vertically) of the recess of the clip base 10, and can be naturally elastically pressed and bound to the teeth 80 inserted through the elastically restoring force of the elastic clip 60 as an elastic structure of a metallic material configured in an internal recess space of the clip base 10, thereby forming an orthodontic clip device of a treatment method and a wearing structure in which a stable fixing (wearing) state can be formed to the teeth 80 to be corrected, while being structurally easily treated and simple.

First, in the clip base 10 made of a ceramic material, so as to be uniformly bonded and bound to the teeth 80, the internal part in the teeth direction as the bonding part 20 directly abutting against the teeth 80 forms a curved surface form to match the correction state of the teeth 80, the internal rear part 30 protrudes to the external side (outside) of the base portion 20, the external front part 40 is formed at an interval with the internal rear part 30 so that the connecting wire 70 can be inserted, seated and bound from top to bottom, the wire insertion hole 11 with open top is formed between the internal rear part 30 and the external front 40, the connecting wire 70 is inserted below the wire insertion hole 11, and the wire fixing hole 12 and the clip operating hole 13 are formed so that the connecting wire 70 is inserted and can be stably seated and bound, while being elastically supported by the internal elastic clip 60. At this time, it is a matter of course that the wire fixing hole 12 and a clip operating hole 13 are a single space, an internal space of the rear of the internal rear part 30 and an internal space of the front of the external front part 40, and form an integral space with the upper wire insertion hole 11.

It is configured so as to be naturally elastically operated to the connecting wire 70 basically installed on the metallic elastic clip 60 formed as the elastic means is basically installed in the clip operating hole 13 communicating with the lower side of the wire insertion hole 11 so that the connecting wire 70 inserted through the clip base 10 and the wire insertion hole 11 can be elastically support, bound and fixed to the space of the wire fixing hole 12 as the clip fixing groove 34 recessed at the front as the internal space of the clip base 10.

In particular, in the orthodontic elastic clip of the present invention, the fixing clip 50 as the same metallic fixing means as the elastic clip 60 is preferably installed, coupled and integrally configured in the clip fixing groove 34 as the wire fixing hole 12 of the internal rear 30 side communicating with the lower side of the wire insertion hole 11 so that the connecting wire 70 inserted through the wire insertion hole 11 of the clip base 10 can smoothly slide and the damage of the clip device can be structurally suppressed. Of course, the fixing clip 50 may be omitted in the configuration relation of the orthodontic clip device according to the present invention to further simplify the overall configuration relation.

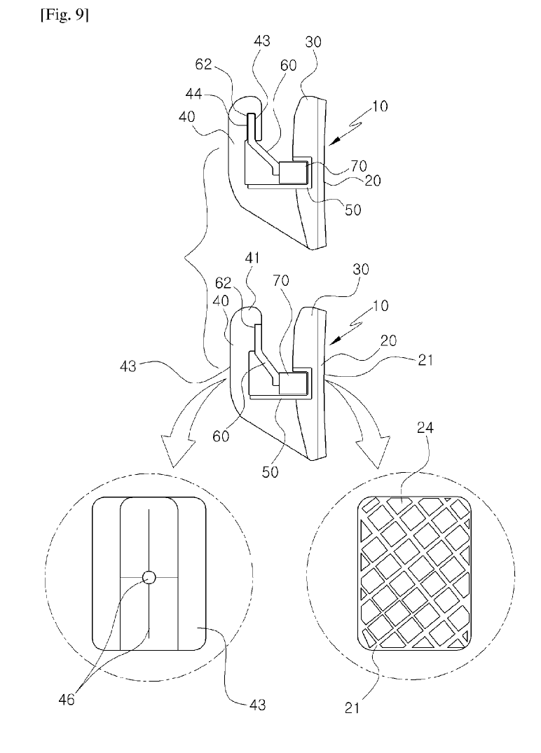

Also, as the coupling state cross-sectional structure comparison diagram of FIG. 9, in the elastic clip 60 forming the elastic structure in which the intermediate part is bent at a certain angle to operate as the elastic supporting means to the teeth 80, the upper support part 62 can be basically integrally coupled to the internal part 42 of the eternal front 40 in which the wire insertion hole 11 is located, or as illustrated in the detailed structural diagram of the operating state of FIG. 7, it can be inserted and coupled to the clip binding groove 44 recessed to open downward to the external front 40.

Further, the elastic clip 60 is preferably configured so that the supporting part 63 protrudes to the lower side below the elastic part 61 while the intermediate elastic part 61 sloping so that the elastic operation can operate to the inserted connecting wire 70, and is grounded to the upper catching part 52 of the fixing clip 50 integrally coupled to the clip fixing groove 34 of the internal rear 30 in which the wire fixing hole 12 is located. This basically prevents the connecting wire 70 of a relatively small caliber from being detached from the wire fixing hole 12 to the outside through the wire insertion hole 11, by allowing the space of the wire fixing hole 12 through which the elastic clip 60 communicates with the wire insertion hole 11 to be blocked before the insertion operation of the connecting wire 70. Especially, the intermediate elastic part 61 of the elastic clip 60 improves the restoring force of the elastic operation, and is preferably formed at an angle capable of preventing scratch in the binding operation in which the connecting wire 70 is seated and elastically supported.

In addition, the clip base 10 as the orthodontic clip constituting the clip device of the present invention is configured so that, in forming the space of the wire insertion hole 11 between the internal part 42 of the external part 40 and the internal outside 30, the open upper space is formed to be smaller in size than the width of the lower space in which the elastic clip 60 is located so that the connecting wire 70 can be smoothly inserted and operated, and the upper parts 31 and 41 and the internal parts 32 and 42 facing each other of the internal rear 30 and the external front 40 forming the wire insertion hole 11 space is preferably generally in a curved surface form. The makes it possible to eliminate the feeling of foreign matter of the tongue and lips in a state of wearing on the teeth, by machining the entire protruding corner part of the clip base 10 as a curved surface and reducing its size, and by allowing the space between the adjacent orthodontic clips to spread somewhat to prevent foreign matter such as food from being structurally caught between the teeth and the orthodontic clip of the present invention, thereby providing the hygienic and aesthetic characteristics and doubling the convenience of use

Also, the base portion 20 of the clip base 10 is preferably configured so that the lower part 23 and the side part are tapered so that the tool can be easily caught when detaching the clip base 10 from the teeth 80, and the bonding part 21 of the base part 20 is preferably formed with a mesh-like embossed surface as illustrated in an enlarged view in a circle of FIG. 9 so that the bonding capability to the teeth 80 is improved.

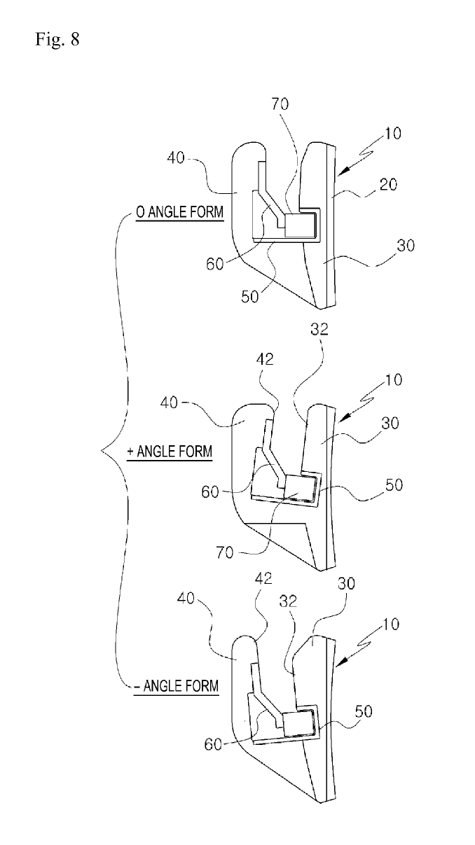

Further, the clip base 10, as illustrated in the cross-sectional structure of FIG. 8, depending on the teeth condition and correcting method, the connecting wire 70 inserted from the top to the bottom through the wire insertion hole 11 can be configured so that the wire insertion hole 11 is formed in a slope direction (+ angle form and − angle form) on the front or rear to the teeth 80, and thus, the elastic clip 60 and the fixing clip 50 are also vertically or obliquely installed and coupled. That is, it is a matter of course that, as the level of the inclination of the wire insertion hole 11 of the upper space and the wire fixing hole 12 and the clip operating hole 13 of the lower space so as to be tilted in the front or rear direction to the teeth 80 based on the vertical direction (0 angle form) parallel to the teeth 80, the elastic clip 60 for elastically supporting the inserted teeth 80 and the fixing clip 50 on which the teeth 80 are seated and bound are also adjusted in angle in proportion thereto.

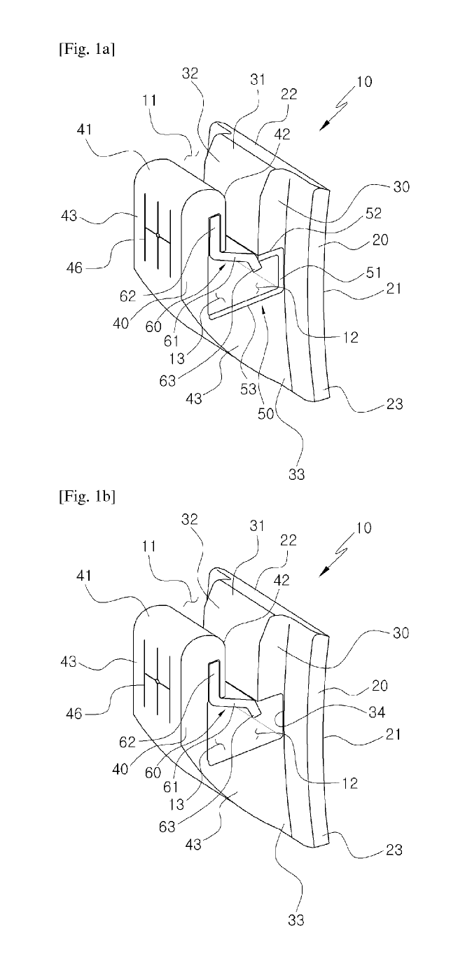

Meanwhile, as illustrated detail in the perspective views of FIGS. 1 and 2 and the enlarged view of FIG. 9, the clip base 10 made of a ceramic material constituting the orthodontic clip device of the present invention is configured so that direction and center mark 46 is preferably formed in the front part 43 of the external front 40 as instruction marks of a line and a circle representing the direction and center of the teeth 80. This can provide an effect of allowing the accurate binding position to be structurally and visually to be performed when attaching the clip base 10 as the orthodontic clip to the teeth 80.

Further, as generally illustrated in the overall configuration diagram, in the present invention, the metallic fixing clip 50 is coupled and fixed and integrally structured, the clip fixing groove 34 forming the wiring fixing hole 12 in a lower recessed space of the internal part 32 of the internal rear 30 is preferably formed in a step shape to be smaller than the cross-sectional area of the connecting wire 70 to be inserted and bound, which has a structural effect of being able to structurally more easily separate the connecting wire 70 during detachment, while being stably inserted and bound during coupling operation of the cross-section of the connecting wire 70 to the clip base 10, and furthermore, allowing more stable binding and fixing state by the supporting operation by the elastic clip 60 of the clip operating hole 13.

In particular, the upper wire insertion hole 11 and the lower wire fixing hole 12 formed in the internal space of the clip base 10 are preferably formed to be greater than the cross-sectional size of the connecting wire 70 at about 0.001 mm to 1.5 mm so that the connecting wire 70 is inserted, seated and bound from the open top (upper) direction to the bottom (lower) direction of the clip base 10, which provides structural characteristics of allowing the maintenance the stable binding state of the connecting wire 70 inserted through the wire insertion hole 11 in the wire fixing hole 12 while being smoothly guided and inserted without shaking rather than the interference fit, thereby allowing the maintenance of the binding state capable of preventing the smooth detachment of the connecting wire 70 after being structurally smoothly inserted.

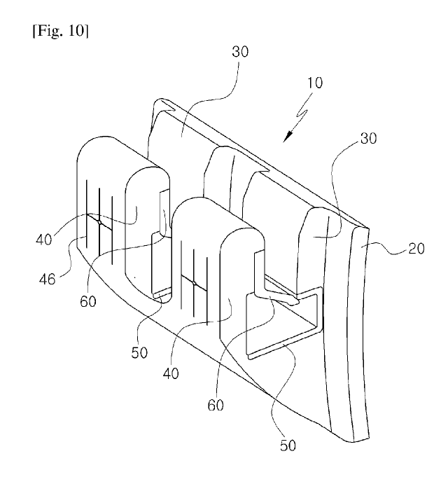

Meanwhile, although the orthodontic clip device of the present invention, as illustrated in the configuration principle described above, the clip base 10 made of the ceramic material and the elastic clip 60 and the fixing clip 50 made of a metallic material are preferably basically formed by in a single structure, applied and embodied, in some cases, as illustrated in the application configuration illustrated in FIG. 10, the configurations of the basic structure may be formed and applied as a plurality of integral structures to be adjacent to each other in a symmetrical manner.

While the present invention has been described with respect to the specific embodiments, it will be apparent to those skilled in the art that various changes and modifications may be made without departing from the spirit and scope of the invention as defined in the following claims.

### Description of Reference Numerals

10 clip base

11 wire insertion hole

12 wire fixing hole

13 clip operating hole

20 base portion

21 bonding part

22 upper part

23 lower part

24 mesh embossed surface

30 internal rear part

31 upper part

32 internal part

33 lower part

34 clip fixing groove

40 external front part

41 upper side part

42 internal part

43 front part

44 lower part

45 clip binding groove

46 direction and center mark

50 fixing clip

51 intermediate fixing part

52 upper catching part

53 lower support part

60 elastic clip

61 elastic part

62 support part

63 pressing part

70 connecting wire

80 teeth

1. An orthodontic clip device comprising:
a clip base (10) made of a ceramic material in which a bonding part (21) of a base portion (20) forms a curved surface shape so as to be evenly coupled and bound to teeth 80, an internal rear portion (30) protrudes to the external side (outside) of the base portion 20, a wire insertion hole (11) with an open top is formed between an external front portion (30) protruding with an interval from the internal rear portion (30) so that a connecting wire (70) can be inserted, and a wire fixing hole (12) and a clip operating hole (13) are formed below the wire insertion hole (11); and
an elastic clip (60) made of a metallic material that is formed as an elastic means in the clip operating hole (13) of the external front side (40) communicating with the lower side of the wire insertion hole (11) so that the connecting wire (70) inserted through the wire insertion hole (11) of the clip base (10) can be elastically supported and bound by the wire fixing hole (12).

2. The device of claim 1, further comprising:
a fixing clip (50) serving as a fixing means made of a metallic material that is coupled to the clip fixing groove (34) as the wire fixing hole (12) of the internal rear side (30) communicating with the lower side of the wire insertion hole (11) so that the sliding can be induced in the connecting wire (70) inserted through the wire insertion groove (11) of the clip base (10) in the binding operation.

3. The device of claim 1, wherein the elastic clip (60) is configured so that the upper support part (62) is integrally coupled to the internal part (42) of the external front part (40) in which the wire insertion hole (11) is located, or is inserted and coupled to a clip binding groove (44) recessed on the external front part (40), an intermediate elastic part (61) is sloped so that the elastic function can be operated on the inserted connecting wire (70), a pressing part (61) protrudes from the lower side below the elastic part (61), and is supported by an upper catching part (52) of the fixing clip (50) integrally coupled to the clip fixing groove (34) of the internal rear part (30) in which the wire fixing hole (12) is located.

4. The device of claim 1, wherein the wire insertion hole (11) of the clip base (10) is configured so that an opened upper space is formed to be smaller in size than a width of the lower space in which the elastic clip (60) is located so that the connecting wire (70) can be smoothly inserted and operated, and the upper parts (32, 41) and the internal parts (32, 42) facing each other of the internal rear part (30) and the external front part (40) forming the wire insertion hole (11) space are generally formed in a curved shape.

5. The device of claim 1, wherein the base part (20) of the clip base (10) is configured so that the lower part (23) and the side part are tapered so that the tool can be caught when detaching the clip base (20) from the teeth (80), and the bonding part (21) of the base portion (21) forms a mesh-like embossed surface so that the bonding capability is improved to the teeth (80).

6. The device of claim 1, wherein the clip base (10) is configured so that the wire insertion hole (11) is formed in a vertical direction (0 angle direction) in which the connecting wire (70) inserted and operated from top to bottom through the wire insertion hole (11) is basically parallel to the teeth (80) depending on the conditions of the teeth and the correcting method, or the wire insertion hole (11) is formed in a slope direction (+ angle form or − angle form) on each of the front or the rear with respect to the teeth(80), and thus, the elastic clip (60) and the fixing clip (50) are also obliquely installed and coupled.

7. The device of claim 1, wherein the clip base (10) is configured so that the direction and center marks (46) are formed on the front part (43) of the external front part (40) as instruction marks of a line and a circle representing the direction and the center to the teeth (80), and the clip fixing groove (34) of the wire fixing hole (12) to which the fixing clip (50) is coupled and fixed is formed to be smaller than the cross-sectional area of the connecting wire (70) to be inserted and bound.

8. The device of claim 1, wherein the clip base (10) made of a ceramic material, and the elastic clip (60) and the fixing clip (50) made of a metallic material are basically configured as a single structure or a plurality of integral structures adjacent to each other.
